(19) United States
(12) Patent Application Publication
(10) Pub. No.: US 2006/0201266 A1
(43) Pub. Date: Sep. 14, 2006

(54) Engine starter designed to have enhanced stability of engagement of pinion with ring gear

(75) Inventors: Sadayoshi Kajino, Nagoya (JP); Youichi Hasegawa, Kasugai-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/354,881

(22) Filed: Feb. 16, 2006

(30) Foreign Application Priority Data
Feb. 28, 2005 (JP) 2005-53057

(51) Int. Cl. F02N 15/06

(52) U.S. Cl. 74/6

(57) ABSTRACT

A starter for automotive engines is provided which is equipped with a pinion carrier which is shifted by a magnetic attraction, as transmitted from a solenoid switch through a shift lever, to establish engagement of a pinion with a ring gear jointed to the engine. If thrust acting on the pinion carrier to urge the pinion against the ring gear through when the pinion has been shifted and hit the ring gear, so that the pinion is placed in abutment with the ring gear is defined as N (Newton), and the mass of the pinion carrier is defined as g (gram), a relation of g/N≦6 is met. This improves the ability of engagement of the pinion with the ring gear, thus resulting in an increased life span of the starter.

### CROSS REFERENCE TO RELATED DOCUMENT

The present application claims the benefits of Japanese Patent Application No. 2005-53057 filed on Feb. 28, 2005, the disclosure of which is incorporated herein by reference.

### BACKGROUND OF THE INVENTION

1. Technical Field of the Invention

The present invention relates generally to a starter which may be employed in starting an automotive engine, and more particularly to an improved structure of such a starter equipped with a pinion carrier which is to be shifted by a magnetic attraction, as transmitted from a solenoid switch through a shift lever, to establish engagement of a pinion with a ring gear jointed to an engine.

2. Background Art

Japanese Utility Model First Publication No. 2-87967 discloses a typical engine starter equipped with an output shaft to which torque of an electric motor is transmitted, a pinion to which the torque is transmitted from the output shaft through a clutch, and a solenoid switch working to turn on or off the motor. When the solenoid switch is actuated, a magnetic attraction is produced to attract a plunger. This movement of the plunger is transmitted to the clutch through a shift lever to shift the pinion along the output shaft along with the clutch for establishing engagement of the pinion with a ring gear joined to an automotive engine.

If the pinion has hit the ring gear and failed to mesh with the ring gear, a drive spring built in the solenoid switch works to store elastic energy or mechanical pressure until main contacts of an on/off switch of the motor are closed. Afterwards, when the main contacts are closed to start the motor, the torque of the motor acts on the pinion, so that the pinion turns. Upon reaching an angular position where the pinion is engageble with the ring gear, the pinion is urged by the pressure exerted from the drive spring into engagement with the ring gear. This structure is, in general, called a drive spring-assisted engagement type.

Recently, for the purpose of improving fuel economy or emission control of automotive vehicles, engine control systems (also called idle stop systems) have been employed gradually which automatically control stop and restart of the engine.

The above described drive spring-assisted engagement type starters are usually designed to have the durability to withstand, for example, over 50000 repeated engagements of the pinion with the gear. The idle stop systems, however, require many repeated uses of the starter and have greater concern about failure in engagement of the pinion with the ring gear occurring early.

### SUMMARY OF THE INVENTION

It is therefore a principal object of the invention to avoid the disadvantages of the prior art.

It is another object of the invention to provide an improved structure of a starter which is designed to have enhanced stability in engagement of a pinion with a ring gear joined to an engine and which is suitable for use in automobiles equipped with an idle stop system.

According to one aspect of the invention, there is provided a starter which may be employed in starting an automotive engine. The starter comprises: (a) an electric motor working to produce torque for starting an engine; (b) a pinion carrier on which a pinion is disposed to be meshable with a ring gear joined to the engine, the pinion carrier being shiftable together with the pinion in a direction away from the motor, the pinion carrier being also adapted to rotate when undergoing the torque, as produced by the motor, to turn the pinion; (c) a solenoid switch working to close switch contacts for actuating the motor and produce magnetic attraction; (d) a shift lever working to undergo the magnetic attraction, as produced by the solenoid switch, to shift the pinion carrier in the direction away from the motor for meshing the pinion with the ring gear to crank the engine; and (e) an urging member working to produce an urging force to urge the pinion against the ring gear through the pinion carrier and the shift lever when the pinion has been shifted away from the motor and hit the ring gear, so that the pinion is placed in abutment with the ring gear. If the urging force is defined as N (newton), and mass of the pinion carrier is defined as g (gram), a relation of g/N≦6 is met.

FIG. 4 demonstrates results of tests to search a relation between the urging force N and the mass g of the pinion carrier. The graph shows that the pinion succeeds 100% in engaging the ring gear over fifty thousands times in a range where the ratio of g/N is. less than or equal to six (6) in each of cases where the pinion carrier is completely hollow, partially hollow, and solid.

For example, when the pinion carrier is completely hollow and 400 g in weight, and the urging force is 70N or more, the pinion has been found to succeed 100% in meshing with the ring gear over fifty thousand times. When the pinion carrier is partially hollow and 550 g in weight, and the urging force is 92N or more, the pinion has been found to succeed 100% in meshing with the ring gear over fifty thousand times. In the former case, the urging force may be decreased by 24% of that used in the latter case, thus allowing the solenoid switch to be decreased in size. The above structure of the starter also results in an increased life-span for which the pinion succeeds in engaging the ring gear, thus meeting operational requirements of the idle stop systems for automotive vehicles over a required period of time.

In the preferred mode of the invention, the urging member is implemented by a mechanical spring which works to store elastic energy between hit of the pinion on the ring gear and when the switch contacts are closed and exert the elastic energy as the urging force on the pinion through the shift lever.

The pinion carrier includes a pinion shaft on which the pinion is installed and to which the torque, as produced by the motor, is transmitted through a clutch. The pinion shaft is joined to an inner periphery of the clutch through splines to be movable in an axial direction thereof. The pinion shaft is at least partially hollow. This results in decreases in mass and torsional rigidity of the pinion shaft. The former permits, as described above, the urging force created by the magnetic attraction produced by the solenoid switch to be decreased. The latter facilitates torsion of the pinion shaft when subjected to impact torque to absorb it. An inner chamber of the pinion shaft may be used as an air vent to minimize a change in pressure within an inner chamber of the clutch which arises from movement of the pinion shaft. This avoids leakage of grease applied between the spline of the pinion shaft and the spline of the clutch and mixing of the grease with another grease used in the clutch.

The pinion shaft has formed therein an annular groove in which an end of the shift lever is fitted.

The pinion carrier may alternatively include a clutch joined to an output shaft of the motor through splines to transmit the torque, as produced by the motor, to the pinion. The clutch is disposed to be movable on the output shaft along with the pinion.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal partial sectional view which shows an internal structure of a starter according to the present invention;

FIG. 2 is an enlarged partial sectional view which shows a clutch and surroundings thereof of the starter, as illustrated in FIG. 1;

FIG. 3 is a schematic view which shows thrust acting on a pinion shaft when a pinion engages a ring gear to crank an engine;

FIG. 4 is a graph which demonstrates results of tests to search a relation between the thrust N, as illustrated in FIG. 3, and the mass g of a pinion carrier; and

FIG. 5 is a schematic view which shows a modified form of a starter.

### DESCRIPTION OF THE PREFERRED EMBODIMENTS

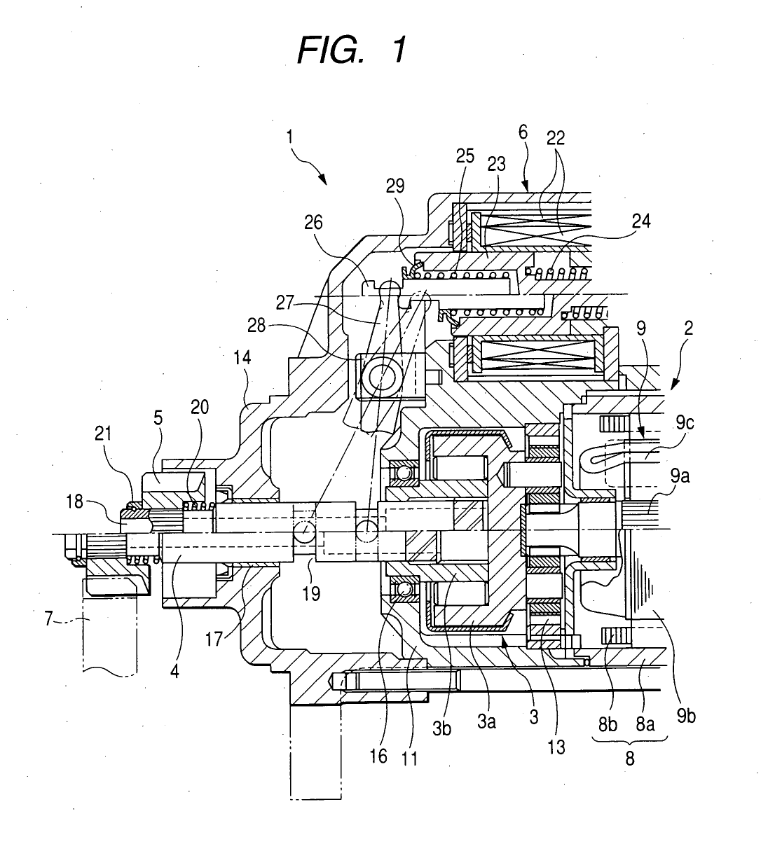

Referring to the drawings, wherein like reference numbers refer to like parts in several views, particularly to FIG. 1, there is shown a starter 1 according to the first embodiment of the invention which may be employed in starting an automotive engine.

The starter 1 consists essentially of a housing 10, an electric motor 2, a speed reducer, as will be described in detail, a clutch 3, a pinion shaft 4, a pinion 5, and a solenoid switch 6. The speed reducer works to reduce an output of the motor 2 in speed and transmit it to the pinion shaft 4 through the clutch 3. The pinion shaft 4 has the pinion gear 5 fitted thereon. The solenoid switch 6 works to close main contacts (not shown) installed in a driver circuit of the motor 2 and advance the pinion shaft 4 in an axial direction thereof. In FIG. 1, an upper side above a longitudinal center line of the pinion shaft 4 illustrates the starter 1 at rest, while a lower side illustrates the starter 1 in motion where the pinion shaft 4 has advanced into engagement of the pinion gear 5 with a ring gear 7 of the engine to crank it.

The motor 2 is a dc motor which includes a field system 8, an armature 9 with a commutator (not shown), and brushes (not shown) riding on the commutator. When the main contacts are closed by the solenoid valve 7, it will cause an electric current to be supplied from a storage battery (not shown) installed in the vehicle to energize the armature 9, so that it produces torque.

The field system 8 is made up of a yoke 8a working to form a magnetic circuit and a plurality of field coils 8b disposed on an inner periphery of the yoke 8a at equi-intervals in a circumferential direction of the yoke 8a. Instead of the field coils 8b, permanent magnets may be used.

The armature 9 is made up of a rotary armature shaft 9a, an armature core 9b fitted on the armature shaft 9a, and an armature coil 9c wound around the armature core 9b. The armature 9 is disposed inside the field system 8 to be rotatable.

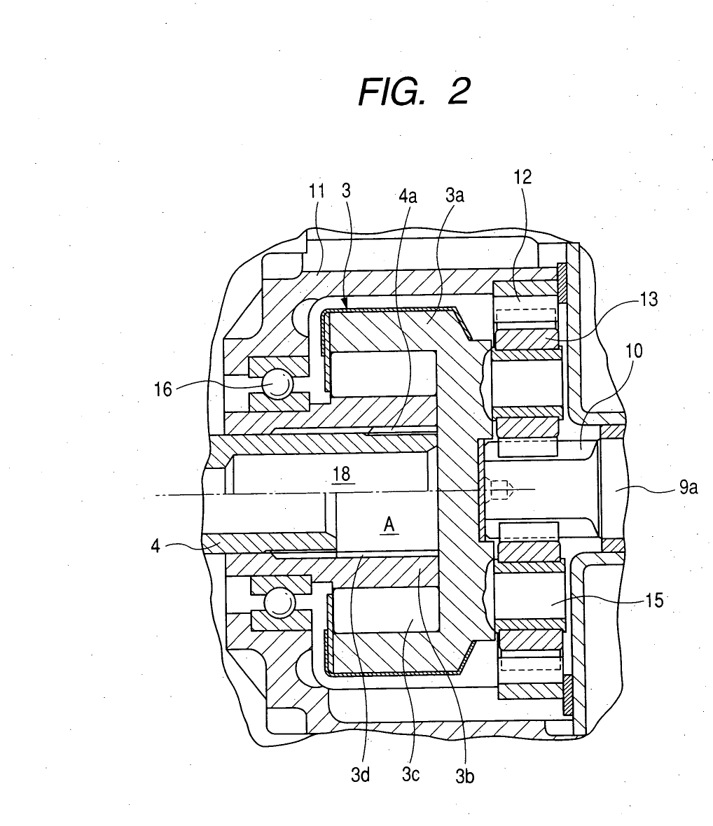

The speed reducer is implemented by a typical epicycle reduction gear train (also called a planetary gear speed reducer) and, as clearly illustrated in FIG. 2, made up of a sun gear 10, a ring-shaped internal gear 12, and planet gears 13. The sun gear 10 is formed on the end of the armature shaft 9a. The internal gear 12 is retained fixedly by a center casing 11. The planet gears 13 are placed in mesh with the gears 10 and 12. The speed reducer works to reduce a rotational speed of the armature 9 to an orbital speed of the planet gears 13.

Referring back to FIG. 1, the center casing 11 is interposed between the yoke 8a and a front housing 14 to embrace the clutch 3 and the speed reducer.

The clutch 3 is implemented by a one-way clutch which is, as clearly shown in FIG. 2, made up of a clutch outer 3a, an inner tube 3b, and rollers 3c. The clutch outer 3a retains the planet gears 13 through the gear shaft 15. The inner tube 3b is disposed inside the clutch outer 3a and retained rotatably by the center casing 11 through a ball bearing 16. The rollers 3c are disposed within cam chambers (not shown) formed in an inner periphery of the clutch outer 3a and work to allow the torque from the clutch outer 3a to be transmitted to the inner tube 3b that is a driven clutch follower and block transmission of torque from the inner tube 3b to the clutch outer 3a.

The pinion shaft 4 is disposed coaxially with the armature shaft 9a of the motor 2. The pinion shaft 4 is supported at the left end thereof, as viewed in FIG. 1, by the front housing 14 through the bearing 17 and has formed on the right end thereof an external helical spline 4a meshing with the internal helical spline 3d of the inner tube 3b.

The pinion shaft 4 is made of a hollow cylindrical shaft which has formed therein an air vent 18 extending through a longitudinal center line of the pinion shaft 4. The pinion shaft 4 also has an annular lever-fit groove 19 which is formed in a central portion of a length thereof to have a diameter smaller than that of the rest of the pinion shaft 4.

The pinion 5 is jointed to the head of the pinion shaft 4 (i.e., a portion projecting from the bearing 17) in a spline fashion to be rotatable in unison with the pinion shaft 4 and also movable relative to the length of the pinion shaft 4 within a given range. The pinion 5 is also urged frontward (i.e., the left in FIG. 1) by a pinion spring 20 disposed between the pinion 5 and the pinion shaft 4 into abutment with a collar 21 working as a stopper installed on the tip of the pinion shaft 4.

The pinion 5, the pinion spring 20, and the stopper 21 are moved along with the pinion shaft 4 in the longitudinal direction of the pinion shaft 4. All such parts (i.e., the pinion shaft 4, the pinion 5, the pinion spring 20, and the stopper 21) constitute a pinion carrier, as will be described later in detail.

The solenoid switch 6 includes a coil 22 excited upon closing of a starter switch (not shown) of the vehicle, a plunger 23 slidable within the coil 22, a return spring 24, and a hook 26. The hook 26 is retained by the plunger 23 through a drive spring 25, as will be described later in detail. When the coil 22 is energized by the starter switch, it will cause the plunger 23 to be magnetically attracted frontward (i.e., the rightward, as viewed in FIG. 1) against a spring pressure of the return spring 24 to advance the pinion shaft 4 through a shift lever 27 fitted in the groove 19. Alternatively, when the coil 22 is deenergized, it will cause the plunger 23 to be moved backward by the return spring 24 to return the pinion shaft 4 through the shift lever 27. The solenoid switch 6, as already described, also works to open or close the main contacts of the driver circuit of the motor 2 according to movement of the plunger 23.

The shift lever 27 is supported by a lever holder 28 to be swingable. The lever holder 28 is secured to the center casing 11. The shift lever 27 has an upper portion, as viewed in FIG. 1, joined to the hook 26 retained by the plunger 35 and a lower portion fitted in the groove 19 of the pinion shaft 4, thereby transferring the movement of the plunger 23 to the pinion shaft 4.

The drive spring 25 is disposed in an inner chamber of the plunger 23 and secured at a left end, as viewed in FIG. 1, to the plunger 23 through a spring bracket 29 and at a right end to the hook 26. After the pinion 5 is moved together with the pinion shaft 4 away from the motor 2 (i.e., the leftward, as viewed in FIG. 1) and hits an end surface of the ring gear 7, the drive spring 25 is compressed to accumulate or store elastic energy (i.e., restorative force) until the main contacts of the driver circuit of the motor 2 are closed. This spring force serves to urge the pinion shaft 4 toward the ring gear 7 through the shift lever 27. Specifically, when, after hitting the ring gear 7, the pinion 5 has turned to an angular position where the pinion 5 is to mesh with the ring gear 7, the spring force of the drive spring 25 works to produce thrust to push the pinion 5 into engagement with the ring gear 7 through the pinion spring 20.

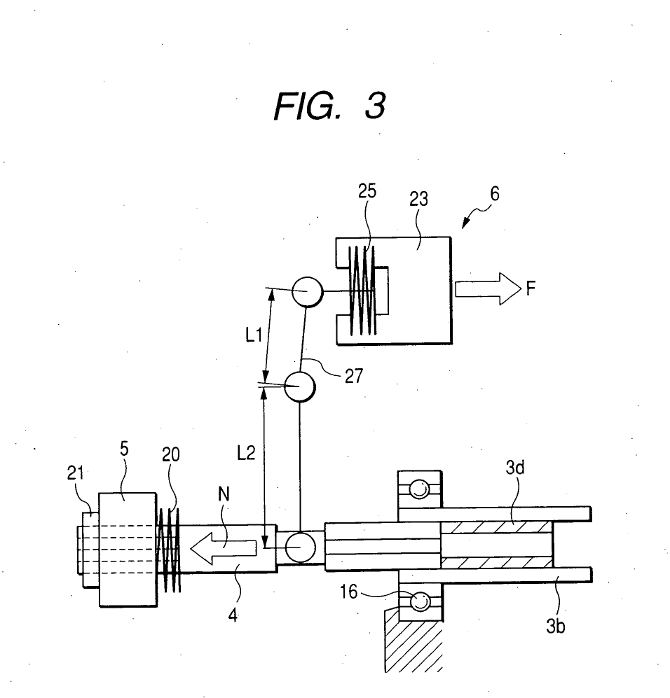

If the thrust, as produced by the drive spring 25, acting on the pinion shaft 4 through the shift lever 27 is, as illustrated in FIG. 3, defined as N, and the spring force, as stored in the drive spring 25 when compressed is defined as F, they will bear the following relation.
N=F×Ll/L2 (1)
where L1 is a length of the shift lever 27 between the center (i.e., the axis) about which the shift lever 27 swings and an end of the shift lever 27 closer to the solenoid switch 6, and L2 is a length of the shift lever 27 between the swing center and the other end thereof closer to the pinion shaft 4.

If the mass of the pinion carrier (i.e., the pinion shaft 4, the pinion 5, the pinion spring 20, and the stopper 21) is defined as g (gram), it has the following relation to the thrust N (Newton).
g/N<6

The operation of the starter 1 will be described below.

When the starter switch is closed to energize the coil 22 of the solenoid switch 6, it will cause the plunger 23 to be attracted rightward, as viewed in FIG. 1, to advance the pinion shaft 4 away from the motor 2 through the shift lever 27. The pinion shaft 4 travels to the left, while rotating relative to the inner tube 3b until the pinion 5 hits at the end surface thereof against the end surface of the ring gear 7. The pinion shaft 4 then compress the pinion spring 20 and stops.

Afterwards, the plunger 23 continues to be attracted while compressing the drive spring 25 and closes the main contacts of the driver circuit of the motor 2. This causes the armature 9 to be energized to produce torque. The torque is increased in magnitude by the speed reducer and transmitted to the pinion shaft 4 through the clutch 3, thereby turning the pinion shaft 4. When the pinion 5 has reached the angular position where the pinion 5 is meshable with the ring gear 7, the thrust N acts on the pinion 5 to bring it into engagement with the ring gear 7. Upon completion of engagement of the pinion 5 with the ring gear 7, the torque is transmitted from the pinion 5 to the ring gear 7 to crank the engine.

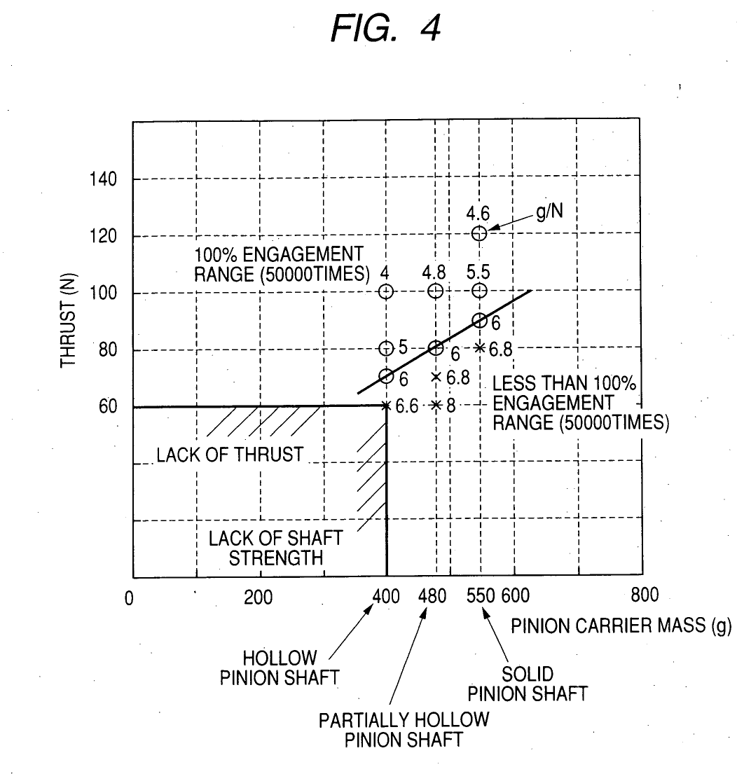

The starter is so designed that the thrust N acting on the pinion shaft 4 through the shift lever 27 after the pinion 5 hits the ring gear 7 and the mass g of the pinion carrier (i.e., the pinion shaft 4, the pinion 5, the pinion spring 20, and the stopper 21), as can be seen from FIG. 4, meet the relation of g/N≦6.

We performed tests to search the life-span of the starter 1 for which the pinion 5 succeeds in meshing with the ring gear 7 completely in terms of the relation between the thrust N and the mass g of the pinion carrier (i.e., g/N). Results of the tests are demonstrated in a graph of FIG. 4. The graph shows that the life-span when g/N is greater than six (6) is different from that when g/N is smaller than six (6). Specifically, it is found that when g/N is greater than six (6), as indicated by “X” in FIG. 4, the number of times the pinion 5 succeeds in meshing with the ring gear 7 is less than fifty thousands, while when g/N is smaller than six (6), as indicated by “◯” in FIG. 4, the number of times the pinion 5 succeeds in meshing with the ring gear 7 is more than fifty thousands. This is because as g/N is decreased below six (6), the thrust N increases relative to the mass g, thereby facilitating the engagement of the pinion 5 with the ring gear 7. This advantage permits the attraction, as produced by the solenoid switch 6, to be decreased, thus allowing the size of the solenoid switch 6 to be decreased. As compared with conventional starters in which g/N is greater than six (6), the starter 1 of this embodiment has an increased life-span and is suitable for automobiles equipped with the idle-stop system, as discussed in the introductory part of this application.

The pinion shaft 4 is, as described above, hollow completely and has the air vent 18 formed therein, thus resulting in a decrease in torsional rigidity thereof. This facilitates torsion of the pinion shaft 4 when subjected to impact torque. The formation of the air vent 18 results in a decrease in mass of the pinion shaft 4, thus facilitating ease of achieving a g/N ratio of six (6) or less without the need for increasing the magnetic attraction to be produced by the solenoid switch 6.

The formation of the air vent 18 also serves to minimize a change in pressure within a chamber A, as illustrated in FIG. 2, defined in the clutch 3 which arises from movement of the pinion shaft 4. This avoids leakage of grease applied between the external helical spline 4a of the pinion shaft 4 and the internal helical spline 3d of the inner tube 3b and mixing of the grease with another grease used in the clutch 3.

The pinion shaft 4, as described above, has the lever-fit groove 19 in which the lower end of the shift lever 27 is fitted. The lever-fit groove 19 is formed by grinding the circumference of the pinion shaft 4 to thin a portion thereof, thus resulting in a decrease in mass of the pinion shaft 4 in addition to that resulting from the formation of the air vent 18. This also facilitates the engagement of the pinion 5 with the ring gear 7. The use of the lever-fit groove 19 eliminates the need for an additional lever bracket retaining the lower end of the shift lever 27, thus resulting in a decrease in production cost of the starter 1.

The starter 1 may be modified as discussed below.

The starter 1 is, as described above, designed to have a g/N ratio of 6 or less. This may be achieved either by a) decreasing the mass g of the pinion carrier, b) by increasing the attraction, as produced by the solenoid switch 6, or c) by selecting a ratio of the length L1 to the length L2 of the shift lever 27 (i.e., L1/L2). The increasing of the attraction, as produced by the solenoid switch 6, will require increasing the size of the coil 22, which will lead to an increase in overall weight of the starter 1. The selection of the L1-to-L2 ratio may require a change in design of the starter 1, thus resulting in an increase in production cost of the starter 1. A g/N ratio of 6 or less is, therefore, most preferably achieved by saving the weight of the pinion carrier. This is achieved in the above embodiment by shaping the pinion shaft 4 to be hollow and grinding the pinion shaft 4 to form the lever-fit groove 19, but may alternatively be achieved by saving the weight of the pinion 5 in a range which ensures the mechanical strength of the pinion 5 required to achieve engagement with the ring gear 7.

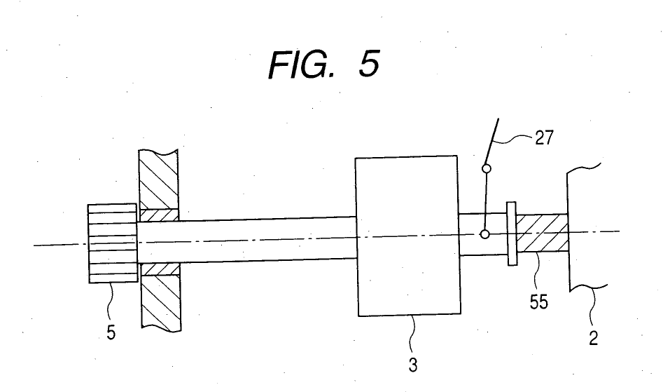

The starter 1 is, as described above, designed so that the pinion shaft 4 on which the pinion 5 is fitted is to be moved in an axial direction thereof and to have the pinion carrier made up of the pinion shaft 4, the pinion 5, the pinion spring 20, and the stopper 21. The invention may be used in a starter, as illustrated in FIG. 5, in which the clutch 3 is joined to an output shaft of the motor 2 through splines 55 so that the clutch 3 may move together with the pinion 5 along the output shaft of the motor 2. In this case, the clutch 3 and the pinion 5 constitute the pinion carrier. A total mass g of the clutch 3 and the pinion 5 and the thrust N acting on the pinion carrier after the pinion 5 hits the ring gear 7 are selected to have a relation of g/N≦6.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A starter for an engine comprising:
an electric motor working to produce torque for starting an engine;
a pinion carrier on which a pinion is disposed to be meshable with a ring gear joined to the engine, said pinion carrier being shiftable together with said pinion in a direction away from said motor, said pinion carrier being also adapted to rotate when undergoing the torque, as produced by said motor, to turn said pinion;
a solenoid switch working to close switch contacts for actuating said motor and produce magnetic attraction;
a shift lever working to undergo the magnetic attraction, as produced by said solenoid switch, to shift said pinion carrier in the direction away from said motor for meshing said pinion with the ring gear to crank the engine; and
an urging member working to produce an urging force to urge the pinion against the ring gear through said pinion carrier and said shift lever when said pinion has been shifted away from said motor and hit the ring gear, so that the pinion is placed in abutment with the ring gear, if the urging force is defined as N (Newton), and mass of said pinion carrier is defined as g (gram), a relation of g/N≦6 being met.

2. A starter as set forth in claim 1, wherein said urging member is implemented by a mechanical spring which works to store elastic energy between hit of the pinion on the ring gear and when the switch contacts are closed and exert the elastic energy as the urging force on the pinion through said shift lever.

3. A starter as set forth in claim 1, wherein said pinion carrier includes a pinion shaft on which the pinion is installed and to which the torque, as produced by said motor, is transmitted through a clutch, the pinion shaft being joined to an inner periphery of the clutch through splines to be movable in an axial direction thereof, the pinion shaft being at least partially hollow.

4. A starter as set forth in claim 3, wherein the pinion shaft has formed therein an annular groove in which an end of said shift lever is fitted.

5. A starter as set forth in claim 1, wherein said pinion carrier includes a clutch joined to an output shaft of said motor through splines to transmit the torque, as produced by said motor, to the pinion, said clutch being disposed to be movable on the output shaft along with the pinion.
